(19) United States
(12) Patent Application Publication
(10) Pub. No.: US 2011/0182408 A1
(43) Pub. Date: Jul. 28, 2011

(54) X-RAY DEVICE FOR CREATING 3D IMAGES OF AN OBJECT UNDER EXAMINATION

(76) Inventors: Harald Graf, Speichersdorf (DE); Stefan Hesl, Eschenbach (DE)

(21) Appl. No.: 13/008,645

(22) Filed: Jan. 18, 2011

(30) Foreign Application Priority Data
Jan. 25, 2010 (DE) 10 2010 005 633.2

(51) Int. Cl. H05G 1/02

(52) U.S. Cl. 378/62; 378/197

(57) ABSTRACT

An X-ray device for creating 3D X-ray images includes a ceiling mount and an X-ray source emitting X-rays. The X-ray source is disposed on the ceiling mount. The X-ray device also includes a first X-ray detector that is connected to the X-ray source via a support bracket. The X-ray source is operable to be moved around an object under examination. The first X-ray detector is operable to be hinged out of a beam path of the X-rays. This provides a greater flexibility in the creation of 3D construction images, in that the X-ray device is not restricted to just one X-ray detector.

This application claims the benefit of DE 10 2010 005 633.2, filed Jan. 25, 2010.

### BACKGROUND

The present embodiments relate to an X-ray device for creating 3D X-ray images.

While 2D projection images already provide a good basis for a doctor to make an assessment, a 3D reconstruction image that has been reconstructed from 2D projection image datasets acquired from different angles offers a volume image that supplies the doctor with even more information for a diagnosis. Such 3D reconstruction image datasets are created for many X-ray examinations. C-arm X-ray systems may be used in the X-ray field for such purposes. A C-arm X-ray system may include an X-ray source and an X-ray detector arranged on a common C-arm. The X-ray source and the X-ray detector may be moved jointly. 2D projection image datasets may be recorded from different directions relative to a static object under examination.

U.S. Pat. No. 5,923,727 describes a C-arm X-ray device, in which the X-ray source and the X-ray detector are arranged opposite to one another on the C-arm. While the series of two-dimensional X-ray image datasets (2D projections) is being acquired, the C-arm may move along a circumference of the C-arm around the patient. From the series of 2D projections, an image processor of the C-arm X-ray device may compute a volume dataset of the inside of the body of a patient.

Such a C-arm X-ray device may not available. More simply structured X-ray devices that include an X-ray source and an X-ray detector that are operable to be moved separately from one another may be available. Either the X-ray source or the X-ray detector or both may be moved. For example, X-ray devices with an X-ray detector that is disposed horizontally in a patient table or vertically on a wall while the X-ray source is arranged on a floor stand or ceiling mount and may be moved in the room are known. Also known is the use of such X-ray devices for creating a 3D reconstruction image. The previously known X-ray devices, however, include a single X-ray detector that has a fixed effective connection to the X-ray source.

### SUMMARY AND DESCRIPTION

The present embodiments may obviate one or more of the drawbacks or limitations in the related art. For example, an improved X-ray device for creating 3D X-ray images of an object under examination may be specified.

An X-ray device for creating 3D X-ray images of the present embodiments includes a ceiling mount and an X-ray source for emitting X-rays, the X-ray source being arranged on the ceiling mount. The X-ray device also includes a first X-ray detector that is connected to the X-ray source via a support bracket. The X-ray source is operable to be moved around an object under examination. The first X-ray detector may be hinged out (e.g., moved out) of the beam path of the X-rays. This provides greater flexibility in the creation of 3D construction images, in that the X-ray arrangement is not restricted to just one X-ray detector.

Advantageously, the X-ray device includes a second X-ray detector that is effectively connected to (e.g., in communication with) the X-ray source, instead of the first X-ray detector being effectively connected to the X-ray source. The first X-ray detector is in a hinged-out position in this case (e.g., outside the beam path of the X-ray source).

In one embodiment, the X-ray device may include a second X-ray detector that is arranged in a table or on a wall. Images of objects under examination that are lying on a table or standing in an upright position may be generated.

The ceiling mount is supported such that the ceiling mount is operable to move in two axes at right angles to one another on the ceiling. The ceiling mount may be positioned freely in a plane that includes the two axes.

In one embodiment, the X-ray source is arranged such that the X-ray source is operable to move along a vertical axis and to rotate. The X-ray source is also arranged such that the X-ray source is operable to rotate about a horizontal axis at right angles to the vertical axis. Together with the axes of movement of the ceiling mount, the X-ray source may be aligned in any number of ways in the room.

The 3D projection image dataset may be created from the at least two 2D projection image datasets in various ways known in the art.

### BRIEF DESCRIPTION OF THE DRAWINGS

FIG. 1 shows one embodiment of an X-ray device with an X-ray detector integrated into a patient table; and

FIG. 2 shows one embodiment of an X-ray device with an X-ray detector arranged on a wall.

### DETAILED DESCRIPTION OF THE DRAWINGS

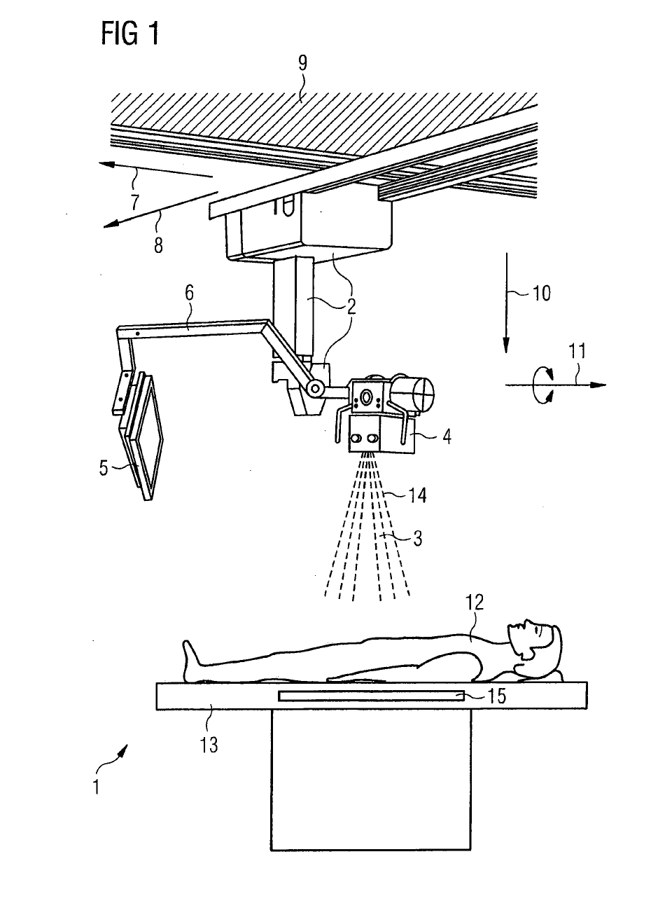

FIG. 1 shows one embodiment of an X-ray device 1 for creating 3D X-ray images. The X-ray device 1 includes a ceiling mount 2, on which an X-ray source 4 that emits X-rays 3 is arranged. The X-ray device 1 also includes a first X-ray detector 5 that is connected to the X-ray device 4 via a support bracket 6.

The ceiling mount 2 is supported to allow movement in two axes 7, 8 at right angles to each other on a ceiling 9. The X-ray source 4 is arranged to allow movement and rotation along a vertical axis 10. The X-ray source 4 is also arranged to allow rotation about a horizontal rotational axis 11 at right angles to the vertical axis 10. The X-ray source 4 is operable to be moved around an object under examination 12, which is supported on a patient table 13.

In the arrangement shown in FIG. 1, the first X-ray detector 5 is hinged out from a beam path 14 of the X-rays 3. In other words, the first X-ray detector 5 is positioned so that the first X-ray detector does not receiving any of the X-rays 3 generated by the X-ray source 4. Integrated into the patient table 13 is a second X-ray detector 15 which, in the arrangement shown in FIG. 1, is effectively connected to (e.g., in communication with) the X-ray source 4 instead of the hinged-out first X-ray detector 5. The second X-ray detector 15 is arranged so that the second X-ray detector 15 receives the X-rays 3 generated by the X-ray source 4.

During the recording of a series of two-dimensional X-ray image datasets (e.g., 2D projections), the X-ray source 4 is moved around the object under examination 12. A 3D X-ray image may be computed using known methods from the series of 2D projections.

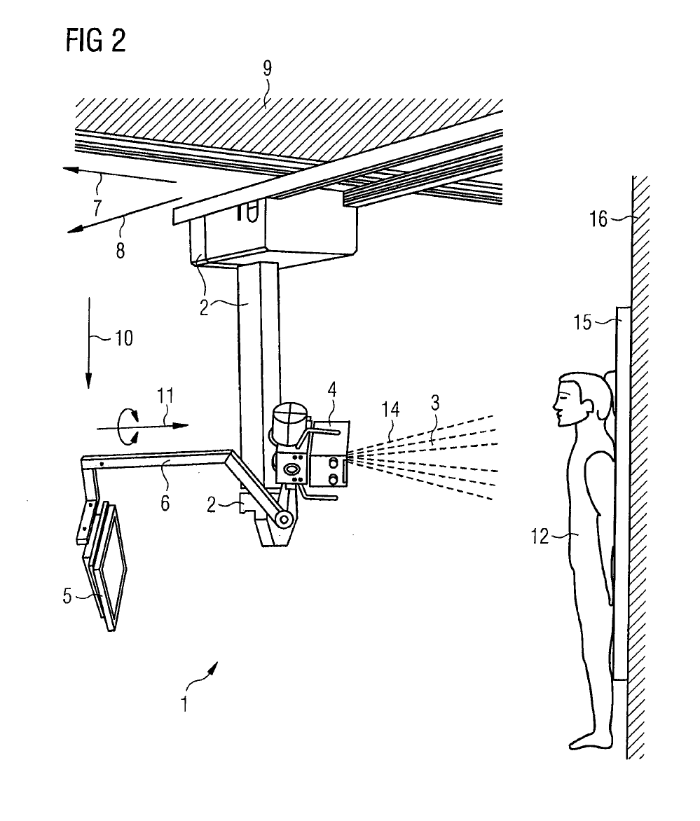

FIG. 2 shows one embodiment of an X-ray device 1 with a second X-ray detector 15 that is arranged on a wall 16. The X-ray source 4, which emits the X-rays 3, is arranged on the ceiling mount 2. The X-ray device 1 includes the first X-ray detector 5, which is connected via the support bracket 6 to the X-ray source 4.

The ceiling mount 2 is supported on the ceiling 9 to allow movement in the two axes 7, 8 at right angles to each other. The X-ray source 4 is arranged to allow movement along and rotation around the vertical axis 10. The X-ray source 4 is also arranged to allow rotation about the horizontal axis of rotation 11 arranged at right angles to the vertical axis 10. The X-ray source 4 is operable to be moved around the object under examination 12, which is located in a standing position in front of the second X-ray detector 15.

The first X-ray detector 5 is hinged out (e.g., moved out) of the beam path 14 of the X-rays 3. The second X-ray detector 15 is effectively connected to (e.g., in communication with) the X-ray source 4 and receives the X-rays 3 generated by the X-ray source 4.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An X-ray device for creating 3D X-ray images, the X-ray device comprising:
a ceiling mount;
an X-ray source that emits X-rays, the X-ray source being disposed on the ceiling mount; and
an X-ray detector that is connected to the X-ray source via a support bracket,
wherein the X-ray source is operable to be moved around an object under examination, and
wherein the X-ray detector is operable to be moved out of the beam path of the X-rays.

2. The X-ray device as claimed in claim 1, wherein the X-ray detector is a first X-ray detector, and
wherein the X-ray device further comprises a second X-ray detector that is operable to be in communication with the X-ray source in place of the moved-out first X-ray detector.

3. The X-ray device as claimed in claim 2, wherein the second X-ray detector is disposed in a patient table or on a wall.

4. The X-ray device as claimed in claim 1, wherein the ceiling mount is supported on a ceiling, such that the ceiling mount is operable to move in two axes at right angles to each other.

5. The X-ray device as claimed in claim 1, wherein the X-ray source is operable to be moved and rotated along a vertical axis and is arranged such that the X-ray source is operable to rotate around a horizontal axis that is at right angles to the vertical axis.

6. The X-ray device as claimed in claim 2, wherein the ceiling mount is supported on a ceiling, such that the ceiling mount is operable to move in two axes at right angles to each other.

7. The X-ray device as claimed in claim 3, wherein the ceiling mount is supported on a ceiling, such that the ceiling mount is operable to move in two axes at right angles to each other.

8. The X-ray device as claimed in claim 2, wherein the X-ray source is operable to be moved and rotated along a vertical axis and is arranged such that the X-ray source is operable to rotate around a horizontal axis that is at right angles to the vertical axis.

9. The X-ray device as claimed in claim 3, wherein the X-ray source is operable to be moved and rotated along a vertical axis and is arranged such that the X-ray source is operable to rotate around a horizontal axis that is at right angles to the vertical axis.

10. The X-ray device as claimed in claim 4, wherein the X-ray source is operable to be moved and rotated along a vertical axis, and
wherein the X-ray source is arranged such that the X-ray source is operable to rotate around a horizontal axis that is at right angles to the vertical axis.

11. The X-ray device as claimed in claim 1, wherein the X-ray detector is operable to be hinged out of the beam path of the X-rays.
